(19) United States
(12) Patent Application Publication
(10) Pub. No.: US 2007/0121831 A1
(43) Pub. Date: May 31, 2007

(54) Apparatus and method for making call connection when parties try to sumultaneously call each other

(75) Inventors: Seong-Gu Kim, Seoul (KR); Jae-Kwon Oh, Seoul (KR); Chan-Ho Ha, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics, Co., Ltd.

(21) Appl. No.: 11/501,908

(22) Filed: Aug. 10, 2006

(30) Foreign Application Priority Data
Aug. 10, 2005 (KR) 2005-73234

(51) Int. Cl. H04M 11/00

(52) U.S. Cl. 379/93.31

(57) ABSTRACT

An apparatus and method for establishing a call connection when two parties try to simultaneously call each other are provided, in which, a simultaneous signal comparator determines, upon receipt of a call connection request, whether a calling terminal and a called terminal are trying to call each other simultaneously, and if the calling terminal and the called terminal are busy when calling each other simultaneously, requests rejection of a call connection request from at least one of the calling terminal and the called terminal, and setup a call connection between the calling terminal and the called terminal. A switch rejects the call connection request from the at least one of the calling terminal and the called terminal, and establishes the call connection between the calling terminal and the called terminal according to the request of the simultaneous signal comparator.

### CROSS-REFERENCE TO RELATED PATENT APPLICATIONS

This application claims the benefit under 35 U.S.C. § 119(a) of a Korean Patent Application filed in the Korean Intellectual Property Office on Aug. 10, 2005 and assigned Ser. No. 2005-73234, the entire disclosure of which is hereby incorporated by reference.

### BACKGROUND OF THE INVENTION

1. Field of the Invention

The present invention relates to an apparatus and method for rejecting a call connection request. More particularly, the present invention relates to an apparatus and method for, when two parties try to call each other simultaneously, rejecting a call connection request from one of the parties in a predetermined rule and making a call connection between the two parties.

2. Description of the Related Art

In a call connection process over an existing wired/wireless telephone network, a caller dials a number of a called party and then the called number is passed to a local switch serving the called party via a local switch serving the caller. If the called party is not busy, a call connection signal is sent to the called party. When the called party answers the call, the call is set up and a conversation starts between the caller and the called party. If the called party is busy, a busy signal is sent to the caller to thereby indicate that the called party is not available.

FIG. 1 illustrates a configuration of a typical wired/wireless telephone network. Referring to FIG. 1, the typical wired/wireless telephone network includes Public Switched Telephone Network (PTSN) switches 116 and 118 for relaying calls to phones 100 and 102, respectively, and Mobile Switching Centers (MSCs) 112 and 114 for relaying calls between mobile terminals 104 and 106 via antennas 108 and 110. When the phones 100 and 102 or the mobile terminals 104 and 106 request a call connection, the PTSN switches 116 and 118 or the MSCs 112 and 114 communicate with the PSTN switch or the MSC of the called party.

When the phone 100 requests a call connection to the mobile terminal 106, the PTSN switch 116 receives the call connection request signal from the phone 100 and determines whether the mobile terminal 106 is available through the MSC 114. If the mobile terminal 106 is busy, the PTSN switch 116 sends busy tones to the phone 100. If the mobile terminal 106 is available, the PTSN switch 116 sends a call connection signal to the mobile terminal 106 through the MSC 114.

Since a determination is made as to whether a call connection can be set up by checking whether the called party is busy, if the called party is trying to call the caller at the same time, the call cannot be connected in a conventional call connection process over the wired/wireless telephone network. That is, when two terminals request a call connection to each other simultaneously, the call connection is not established between the two terminals.

Due to the development and proliferation of mobile terminals and phones, mobile terminals and phones have become a necessity. Particularly, a resulting increase in a number of calls often causes call drops in mobile terminals and phones. Accordingly, there is a need for an improved apparatus and method for establishing a call connection between two parties when the two parties make calls to each other simultaneously.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus and method for establishing a call connection between two parties when the two parties make calls to each other simultaneously.

Another aspect of exemplary embodiments of the present invention is to provide an apparatus and method for, when two parties try to call each other simultaneously, rejecting a call connection request from one of the parties in a predetermined rule and making a call connection between the two parties.

The above aspects are achieved by providing an apparatus and method for establishing a call connection when both parties try to simultaneously call each other.

According to one aspect of exemplary embodiments of the present invention, in a simultaneous call connection apparatus, a simultaneous signal comparator determines, upon receipt of a call connection request, whether a calling terminal and a called terminal are trying to call each other simultaneously, and if the calling terminal and the called terminal are busy when calling each other simultaneously, requests rejection of a call connection request from one of the calling terminal and the called terminal and setup of a call connection between the calling terminal and the called terminal. A switch rejects the call connection request from the one of the calling terminal and the called terminal and establishes the call connection between the calling terminal and the called terminal according to the request of the simultaneous signal comparator.

According to another aspect of exemplary embodiments of the present invention, in a simultaneous call connection method in a simultaneous call connection apparatus, upon receipt of a call connection request in a simultaneous call mode, information about a called terminal is verified. A determination is made as to whether the called terminal is requesting a call connection to a calling terminal simultaneously. If the calling terminal and the called terminal are busy when requesting the call connection to each other simultaneously, the call connection request from the called terminal is rejected, and a connection command is sent to a simultaneous call connection apparatus which has sent the call connection request from the calling terminal.

According to a further aspect of exemplary embodiments of the present invention, in a simultaneous call connection method in a simultaneous call connection apparatus, upon receipt of a call connection request in a simultaneous call mode, information about a called terminal is verified. A determination is made as to whether the called terminal is requesting a call connection to a calling terminal simultaneously in the simultaneous call mode by comparing the information about the called terminal and stored call connection information. If the calling terminal and the called terminal are busy in requesting the call connection to each other simultaneously, a terminal whose call connection request is rejected is selected in a method. If the simultaneous call connection apparatus includes a non-selected terminal, a simultaneous call connection apparatus including the selected terminal is requested to reject the call connection request from the selected terminal. The call connection is then established.

### BRIEF DESCRIPTION OF THE DRAWINGS

The above and other objects, features and advantages of certain exemplary embodiments of the present invention will be more apparent from the following detailed description taken in conjunction with the accompanying drawings in which:

FIG. 1 illustrates a configuration of a typical wired/wireless telephone network;

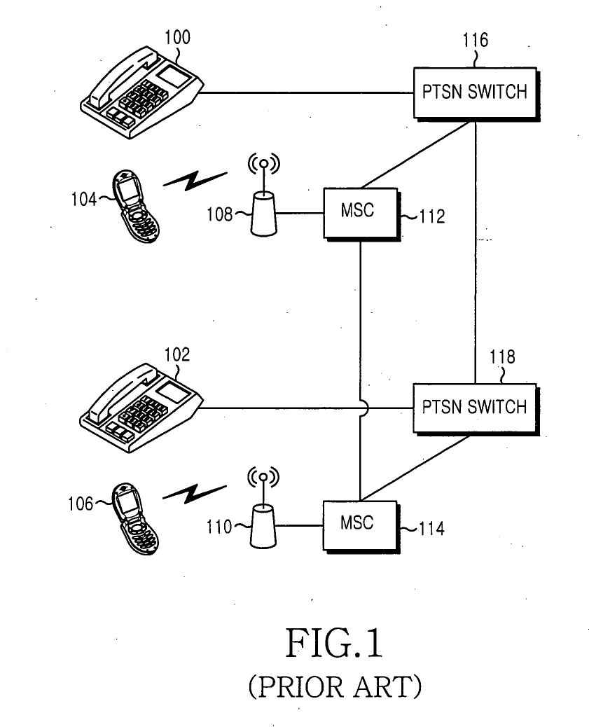

FIG. 2 illustrates a configuration of a simultaneous call connection apparatus according to an exemplary embodiment of the present invention;

FIG. 3 is a diagram illustrating a signal flow for a simultaneous call connection operation in a communication system supporting a call connection for simultaneous call connection requests according to an exemplary embodiment of the present invention;

FIG. 4 is a diagram illustrating a signal flow for a simultaneous call connection operation in the communication system supporting a call connection for simultaneous call connection requests according to an exemplary embodiment of the present invention; and

FIG. 5 is a flowchart illustrating a simultaneous call connection operation in the simultaneous call connection apparatus when a call connection request is received in a simultaneous call mode according to an exemplary embodiment of the present invention.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Embodiments of the present invention are intended to provide an apparatus and method for establishing a call connection between two parties when the two parties make calls to each other simultaneously.

Before describing the present invention, terms used herein are defined as follows. “Simultaneous call connection” is a call connection established between both parties when the two parties make calls to each other simultaneously, “simultaneous call connection apparatus” is an apparatus for establishing the simultaneous call connection, and “simultaneous call mode” is a mode set to establish the simultaneous call connection.

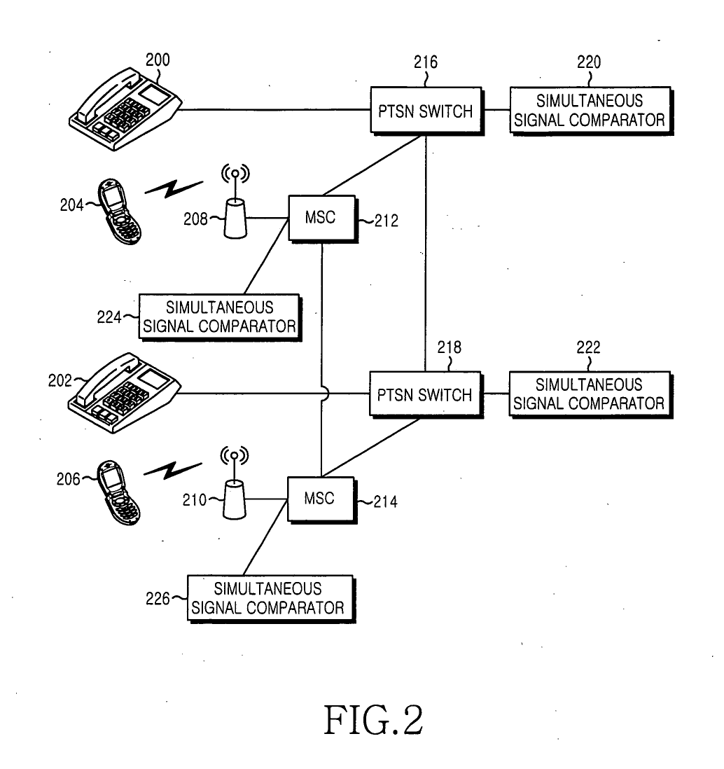

FIG. 2 illustrates the configuration of a simultaneous call connection apparatus according to an exemplary embodiment of the present invention.

Referring to FIG. 2, the simultaneous call connection apparatus includes phones 200 and 202, mobile terminals 204 and 206, PTSN switches 216 and 218, antennas 208 and 210, MSCs 212 and 214, and simultaneous signal comparators 220, 222, 224 and 226.

When the PTSN switches 216 and 218 or the MSCs 212 and 214 receive a call connection request in a simultaneous call mode from the phones 200 and 202 or the mobile terminals 204 and 206, the PTSN switches 216 and 218 or the MSCs 212 and 214 provide the call connection request to a corresponding simultaneous signal comparator, reject a call connection request from the caller or the called party upon request of the simultaneous signal comparator, and then establish a call connection between the caller and the called party.

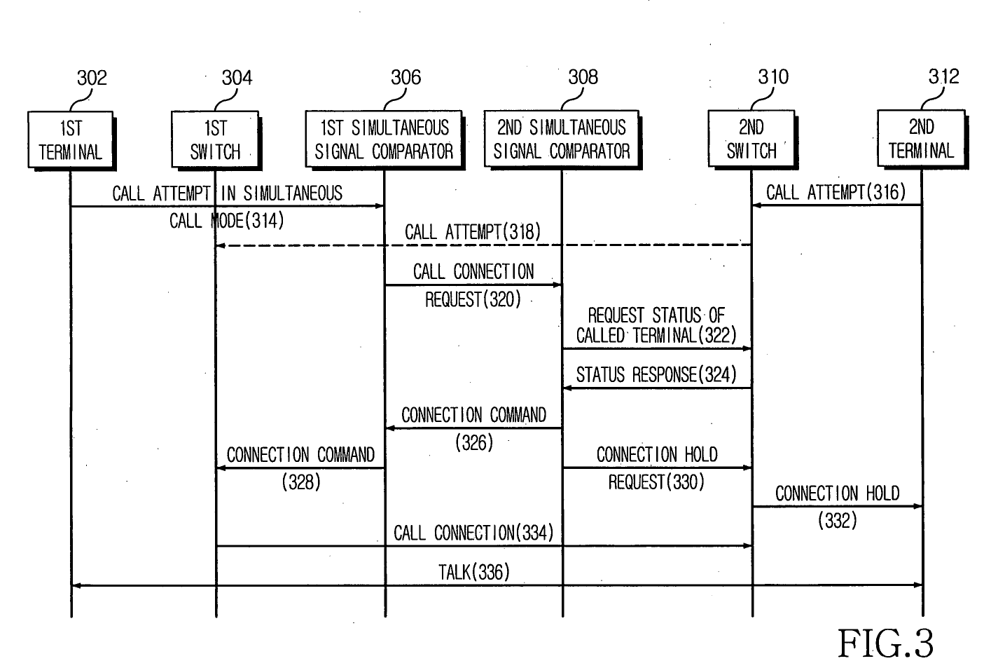

Upon receipt of a call connection request signal from a PTSN switch or an MSC, each of the simultaneous signal comparators 220, 222, 224 and 226 determines whether a caller and a called party associated with the call connection request signal are attempting to call each other, that is, in a simultaneous busy state. If the caller and called party are busy simultaneously, the simultaneous signal comparator requests the PTSN switch or the MSC to reject a call connection request from the caller or the called party and makes a call connection between the caller and the called party. A detailed description of a call connection in the case of simultaneous call connection requests will be given later with reference to FIGS. 3, 4 and 5.

In an exemplary implementation, the PTSN switches 216 and 218 or the MSCs 212 and 214 may be configured to perform the functionality of the simultaneous signal comparators 220, 222, 224 and 226, while the simultaneous signal comparators 220, 222, 224 and 226 are shown separately from the PTSN switches 216 and 218 and the MSCs 212 and 214, for better understanding of the functionality of the simultaneous signal comparators 220 to 226. In other words, the simultaneous signal comparators 220, 222, 224 and 226 can be incorporated into the PTSN switches 216 and 218 or the MSCs 212 and 214 or separately configured from the PTSN switches 216 and 218 and the MSCs 212 and 214.

FIG. 3 is a diagram illustrating a signal flow for a simultaneous call connection operation in a communication system supporting a call connection for simultaneous call connection requests according to an exemplary embodiment of the present invention.

In FIG. 3, two terminals are attempting to make calls to each other simultaneously, in which one of the terminals makes a call in a simultaneous call mode. Referring to FIG. 3, when a first terminal 302 requests a first simultaneous signal comparator 306 to make a call connection to a second terminal 312 in the simultaneous call mode through a first switch 304 in step 314, the first simultaneous signal comparator 306 stores call connection information, generates a call connection request signal containing the phone number of the called second terminal 312, and sends the call connection request signal to a second simultaneous signal comparator 308 serving the second terminal 312.

Without knowing the call attempt from the first terminal 302, the second terminal 312 attempts to call the first terminal 302 through a second switch 310 in step 316. The second switch 310 attempts the call to the first switch 304 in step 318, and at the same time, the second terminal 312 is transitioned to a busy state.

Meanwhile, the second simultaneous signal comparator 308 searches for call connection information corresponding to the called number set in the call connection request signal received in step 320. In the absence of the call connection information, the second simultaneous signal comparator 308 requests the second switch 310 to check the state of the called second terminal 312 in step 322 and receives a response for the state check request from the second switch 310 in step 324. If the response indicates the second terminal 312 is attempting to call the first terminal 302, the second simultaneous signal comparator 308 sends a connection command to the first simultaneous signal comparator 306 in step 326. In step 330, the second simultaneous signal comparator 308 sends a connection hold request to the second switch 310.

The first simultaneous signal comparator 306 forwards the connection command to the first switch 304 in step 328. In step 332, the second simultaneous signal comparator 310 rejects the call connection request from the second terminal 312 and the second switch 310 sends a connection hold signal to the second terminal 312.

Upon receipt of the connection command, the first switch 304 establishes a call connection with the second switch 310 in step 334 and thus, the first terminal 302 makes a conversation with the second terminal 312 in step 336.

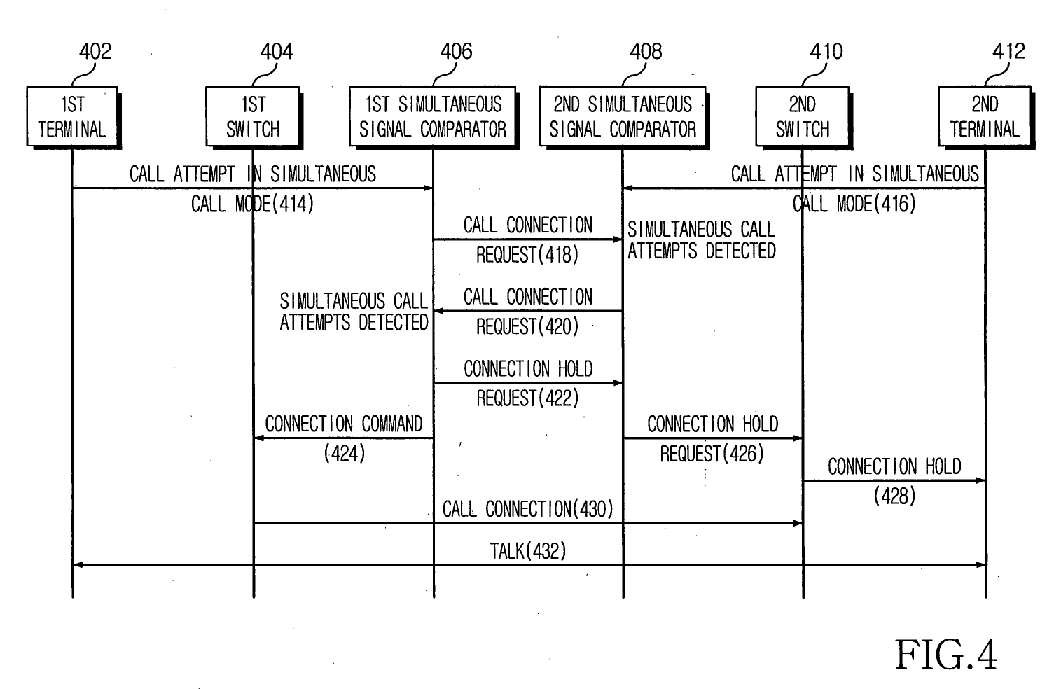

FIG. 4 is a diagram illustrating a signal flow for a simultaneous call connection operation in the communication system supporting a call connection for simultaneous call connection requests according to an exemplary embodiment of the present invention.

In the illustrated case of FIG. 4, two terminals try to call each other simultaneously in the simultaneous call mode. Referring to FIG. 4, when a first terminal 402 requests a first simultaneous signal comparator 406 to make a call connection to a second terminal 412 through a first switch 404 in the simultaneous call mode in step 414, the first simultaneous signal comparator 406 stores call connection information and sends a call connection request signal including the phone number of the called second terminal 412 to a second simultaneous signal comparator 408 serving the second terminal 412 in step 418.

Without knowing the call attempt from the first terminal 402, the second terminal 412 attempts to call the first terminal 402 through a second switch 410 in the simultaneous call mode in step 416. The second simultaneous signal comparator 408 stores call connection information associated with the call attempt and sends a call connection request signal including the phone number of the called first terminal 402 to the first simultaneous signal comparator 406 in step 420.

Meanwhile, the second simultaneous signal comparator 408 searches for call connection information corresponding to the called number set in the call connection request signal received in step 418. In the presence of the call connection information, the second simultaneous signal comparator 408 recognizes that the first and second terminals 402 and 412 have requested the call connection simultaneously and selects a terminal whose call connection request will be rejected. If the call connection request from the second terminal 412 is rejected, the second simultaneous signal comparator 408 receives a connection hold request from the first simultaneous signal comparator 406 in step 422 and forwards the connection hold request to the second switch 410 in step 426.

The first simultaneous signal comparator 406 searches for call connection information corresponding to the called number set in the call connection request signal received in step 420. In the presence of the call connection information, the first simultaneous signal comparator 406 recognizes that the first and second terminals 402 and 412 have requested the call connection simultaneously and selects a terminal whose call connection request will be rejected. If the call connection request from the second terminal 412 is rejected, the first simultaneous signal comparator 406 sends the connection hold request to the second simultaneous signal comparator 408 in step 422 and sends a connection command to the first switch 404 in step 424. In step 428, the second simultaneous signal comparator 408 rejects the call connection request from the second terminal 412 and the second switch 410 sends a connection hold signal to the second terminal 412.

Upon receipt of the connection command, the first switch 404 establishes a call connection with the second switch 410 in step 430 and thus, the first terminal 402 converses with the second terminal 412 in step 432.

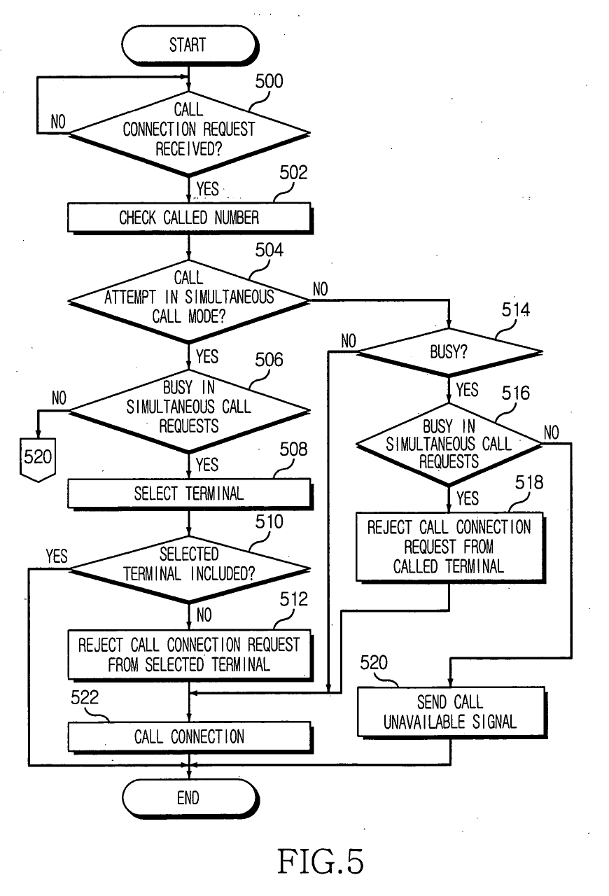

FIG. 5 is a flowchart illustrating a simultaneous call connection operation in the simultaneous call connection apparatus illustrated in FIG. 2 when a call connection request is received in the simultaneous call mode according to an exemplary embodiment of the present invention.

Referring to FIG. 5, upon receipt of a call connection request from a calling terminal in step 500, the simultaneous call connection apparatus checks a called number in step 502 and determines whether a called terminal is attempting a call by searching stored call connection information in step 504.

If the called terminal is attempting to call the calling terminal, the simultaneous call connection apparatus determines whether the calling terminal and the called terminal associated with the call connection request are requesting call connection to each other simultaneously by comparing the call connection request signal with the stored call connection information in step 506. If they are not attempting to call each other at the same time, the simultaneous call connection apparatus sends a call unavailable signal to the calling terminal in step 520.

On the other hand, if both the calling terminal and the called terminal are trying to call each other simultaneously, the simultaneous call connection apparatus selects one of the terminals of which the call connection request is to be rejected in a predetermined method in step 508. The predetermined method can be to select a terminal whose phone number is larger or less than that of the other terminal by comparing the phone numbers of the two terminals partially or wholly.

In step 510, the simultaneous call connection apparatus determines whether the calling terminal and the called terminal belong to different simultaneous call connection apparatuses and the selected terminal belongs to the simultaneous call connection apparatus. If the calling terminal and the called terminal belong to different simultaneous call connection apparatuses and the selected terminal belongs to the simultaneous call connection apparatus, a control operation for simultaneous call connection is carried out in the other simultaneous call connection apparatus.

If the simultaneous call connection apparatus includes the calling terminal and the called terminal or does not include the selected terminal, the simultaneous call connection apparatus requests the other simultaneous call connection apparatus to reject the call connection request from the selected terminal and output a connection hold signal to the selected terminal in step 512 and establishes the call connection in step 522.

Meanwhile, if the called terminal is not attempting a call in the simultaneous call mode in step 504, the simultaneous call connection apparatus determines whether the called terminal is busy in step 514. If the called terminal is not busy, the simultaneous call connection apparatus establishes the call connection in step 522.

If the called terminal is busy in step 514, the simultaneous call connection apparatus determines whether the calling terminal and the called terminal are requesting the call connection to each other simultaneously in step 516. If they are not, the simultaneous call connection apparatus sends the call unavailable signal to the calling terminal in step 520.

If the calling terminal and the called terminal are requesting the call connection to each other simultaneously, the simultaneous call connection apparatus rejects the call connection request from the called terminal and sends the connection hold signal to the called terminal in step 518 and establishes the call connection by sending a connection command to a simultaneous call connection apparatus that has sent the call connection request signal in step 522.

Exemplary embodiments of the present invention can also be embodied as computer-readable codes on a computer-readable recording medium. The computer-readable medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, can carrier waves (such as data transmission through the Internet via wired or wireless transmission paths). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains.

As described above, the exemplary embodiments of present invention provides an apparatus and method for, when two parties try to call each other simultaneously, rejecting a call connection request from one of the parties in a predetermined rule and making a call connection between the two parties. Therefore, when phone users attempt to call each other at the same time, a call can be made between the phone users, thus increasing user convenience.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A simultaneous call connection apparatus comprising:
a simultaneous signal comparator for determining whether a calling terminal and a called terminal are trying to call each other simultaneously, and when calling each other simultaneously, requesting rejection of a call connection request from one of the calling terminal and the called terminal and setup of a call connection between the calling terminal and the called terminal; and
a switch for rejecting the call connection request from the one of the calling terminal and the called terminal, and establishing the call connection between the calling terminal and the called terminal according to the request of the simultaneous signal comparator.

2. The simultaneous call connection apparatus of claim 1, wherein upon receipt of a call connection request in a simultaneous call mode from a terminal belonging to the switch, the switch provides the call connection request to the simultaneous signal comparator in the simultaneous call mode.

3. The simultaneous call connection apparatus of claim 2, wherein upon receipt of the call connection request in the simultaneous call mode, the simultaneous signal comparator generates a call connection request signal and sends the call connection request signal to a simultaneous call connection apparatus including the called terminal.

4. The simultaneous call connection apparatus of claim 1, wherein if the called terminal attempts to call the calling terminal, the simultaneous signal comparator requests the switch to reject the call connection request from the called terminal and establish the call connection between the calling terminal and the called terminal.

5. The simultaneous call connection apparatus of claim 1, wherein if the called terminal attempts to call the calling terminal in the simultaneous call mode, the simultaneous signal comparator selects one of the calling terminal and the called terminal, of which the call connection request is rejected in a method, and requests the switch to reject the call connection request from the selected terminal and establish the call connection between the calling terminal and the called terminal.

6. The simultaneous call connection apparatus of claim 5, wherein the method selects a terminal whose phone number is at least one of larger than the phone number and less than the phone number of the other terminal by comparing at least one of whole phone numbers and parts of phone numbers of the calling and called terminals.

7. The simultaneous call connection apparatus of claim 1, wherein the simultaneous signal comparator requests the switch to send a connection hold signal to the selected terminal whose call connection request has been rejected until the call connection.

8. A simultaneous call connection method in a simultaneous call connection apparatus, comprising:
verifying information about a called terminal, upon receipt of a call connection request;
determining whether the called terminal is requesting a call connection to a calling terminal simultaneously;
rejecting the call connection request from one of the called terminal and calling terminal when requesting the call connection to each other simultaneously; and
establishing the call connection between called terminal and calling terminal.

9. The simultaneous call connection method of claim 8, further comprising sending a connection hold signal to the called terminal until the call connection, after rejecting the call connection request.

10. The simultaneous call connection method of claim 8, further comprising:
detecting a called simultaneous call connection apparatus, upon receipt of a call connection request in the simultaneous call mode from a terminal belonging to the simultaneous call connection apparatus; and
generating a call connection request signal and sending the call connection request signal to the called simultaneous call connection apparatus.

11. A simultaneous call connection method in a simultaneous call connection apparatus, comprising:
verifying information about a called terminal, upon receipt of a call connection request in a simultaneous call mode;
determining whether the called terminal is requesting a call connection to a calling terminal simultaneously in the simultaneous call mode by comparing information regarding the called terminal and stored call connection information;
selecting a terminal whose call connection request is rejected in a method, if both the calling terminal and the called terminal are busy when requesting the call connection to each other simultaneously; and
requesting a simultaneous call connection apparatus including the selected terminal to reject the call connection request from the selected terminal, if the simultaneous call connection apparatus includes a non-selected terminal; and
establishing the call connection.

12. The simultaneous call connection method of claim 11, wherein the requesting of the simultaneous call connection apparatus comprises sending a connection hold signal to the selected terminal until before the call connection.

13. The simultaneous call connection method of claim 11, further comprising:
receiving a request for rejecting the call connection from the selected terminal from a simultaneous call connection apparatus including the non-selected terminal after the selecting of the terminal, if the simultaneous call connection apparatus includes the selected terminal; and
rejecting the call connection request from the selected terminal.

14. The simultaneous call connection method of claim 13, further comprising, after the receiving of the request for rejection, sending a connection hold signal to the selected terminal until the call connection.

15. The simultaneous call connection method of claim 11, wherein the predetermined method is to select a terminal whose phone number is at least one of larger than the phone number and less than the phone number of the other terminal by comparing at least one of whole phone numbers and parts of phone numbers of the calling and called terminals.

16. The simultaneous call connection method of claim 11, further comprising:
detecting a called simultaneous call connection apparatus, upon receipt of a call connection request in the simultaneous call mode from a terminal belonging to the simultaneous call connection apparatus; and
generating a call connection request signal and sending the call connection request signal to the called simultaneous call connection apparatus.

17. A computer-readable medium comprising a computer program for executing a simultaneous call connection method, the method comprising:
verifying information about a called terminal, upon receipt of a call connection request in a simultaneous call mode;
determining whether the called terminal is requesting a call connection to a calling terminal simultaneously;
rejecting the call connection request from the called terminal if the calling terminal and the called terminal are busy when requesting the call connection to each other simultaneously; and
sending a connection command to a simultaneous call connection apparatus which has sent the call connection request from the calling terminal.

18. The method of claim 17, further comprising sending a connection hold signal to the called terminal until the call connection, after rejecting the call connection request.

19. The method of claim 17, further comprising:
detecting a called simultaneous call connection apparatus, upon receipt of a call connection request in the simultaneous call mode from a terminal belonging to the simultaneous call connection apparatus; and
generating a call connection request signal and sending the call connection request signal to the called simultaneous call connection apparatus.

20. A simultaneous call connection apparatus comprising:
a switch for determining whether a calling terminal and a called terminal are trying to call each other simultaneously, and when calling each other simultaneously, rejecting a call connection request from one of the calling terminal and the called terminal and establishing setup of a call connection between the calling terminal and the called terminal.
